(19) United States
(12) Patent Application Publication
(10) Pub. No.: US 2013/0321420 A1
(43) Pub. Date: Dec. 5, 2013

(54) RAY-NODE TEST USING INTEGER COMPARISONS

(71) Applicants: Samuli Matias Laine, Vantaa (FI); Timo Oskari Aila, Tuusula (FI)

(72) Inventors: Samuli Matias Laine, Vantaa (FI); Timo Oskari Aila, Tuusula (FI)

(73) Assignee: NVIDIA CORPORATION, Santa Clara, CA (US)

(21) Appl. No.: 13/587,736

(22) Filed: Aug. 16, 2012

Related U.S. Application Data
(60) Provisional application No. 61/652,747, filed on May 29, 2012.

(51) Int. Cl. G06T 15/06

(52) U.S. Cl. 345/426

(57) ABSTRACT

A method including performing ray traversal wherein the ray traversal includes determining boxes intersected by a ray. The ray traversal includes performing a ray-box intersection test including calculating plane intersections, and determining comparisons of two operands wherein each operand is a binary representation of a floating point value and wherein further the determining comparisons operation is performed using an integer unit of the computer graphics system. The ray-box intersection test further includes, responsive to results of the comparisons, calculating span intersections of the boxes.

### CROSS-REFERENCE TO RELATED APPLICATION

This application claims priority from U.S. Provisional Application No. 61/652,747, filed May 29, 2012, entitled “RAY-NODE TEST USING INTEGER COMPARISONS,” by Laine, S., attorney docket number NVID-P-HE-12-0211-US0 which is hereby incorporated by reference.

### BACKGROUND OF THE INVENTION

In image rendering in a computer graphics system, one time consuming stage of ray tracing is the acceleration structure traversal. During this traversal, it is determined whether a ray intersects one or more nodes, and decided where to traverse next. Typically, the nodes are modeled as axis-aligned boxes. Most of the calculations are performed using floating point instructions within the computer graphics system. However, often times, the integer unit of the computer graphics system is left idle.

### BRIEF SUMMARY OF THE INVENTION

Accordingly, a need exists for a computer graphics method to make better use of an idle integer unit. The present invention discloses a computer graphics method to carry out a ray versus axis-aligned box test using integer instructions even though the data is in floating point format.

More specifically, embodiments of the present invention are directed towards a computer graphics method. The computer controlled method includes performing ray traversal wherein the ray traversal comprises determining boxes intersected by a ray. The boxes include objects within a three dimensional scene. The ray traversal comprises performing a ray-box intersection test including calculating span intersections, and determining comparisons of two operands wherein each operand is a binary representation of a floating point value and wherein further the determining comparisons operation is performed using an integer unit of the computer graphics system. The ray-box intersection test further includes, responsive to the results of the comparisons, calculating the span of the ray intersecting the box.

In another embodiment, the present invention is drawn to a computer readable storage medium having stored thereon, computer executable instructions that, if executed by a computer system cause the computer system to perform a method of ray tracing. The computer controlled method includes performing ray traversal wherein the ray traversal comprises determining boxes intersected by a ray. The boxes include objects within a three dimensional scene. The ray traversal comprises performing a ray-box intersection test including calculating span intersections, and determining comparisons of two operands wherein each operand is a binary representation of a floating point value and wherein further the determining comparisons operation is performed using an integer unit of the computer graphics system. The ray-box intersection test further includes, responsive to the results of the comparisons, calculating the span of the ray intersecting the box.

In yet another embodiment, the present invention is drawn to a system. The system comprises a processor coupled to a computer readable storage media using a bus and executing computer readable code which causes the computer system to perform a method of rendering an image. The computer controlled method includes performing ray traversal wherein the ray traversal comprises determining boxes intersected by a ray. The boxes include objects within a three dimensional scene. The ray traversal comprises a ray-box intersection test including calculating span intersections, and determining comparisons of two operands wherein each operand is a binary representation of a floating point value and wherein further the determining comparisons operation is performed using an integer unit of the computer graphics system. The ray-box intersection test further includes, responsive to the results of the comparisons, calculating the span of the ray intersecting the box.

### BRIEF DESCRIPTION OF THE DRAWINGS

The embodiments of the present invention are illustrated by way of example, and not by way of limitation, in the figures of the accompanying drawings and in which like reference numerals refer to similar elements.

FIG. 1A shows an exemplary computer system, in accordance with one embodiment of the present invention.

FIG. 1B shows an exemplary graphics processing unit (GPU) comprising a plurality of integer execution units and a plurality of floating point execution units, in accordance with one embodiment of the present invention.

FIG. 1C shows an exemplary central processing unit (CPU) comprising a plurality of integer execution units and a plurality of floating point execution units, in accordance with one embodiment of the present invention.

FIG. 2A depicts computing a minimum distance and a maximum distance along an individual ray by intersecting the ray with two planes having a constant x value within an exemplary three dimensional scene, in accordance with one embodiment of the present invention.

FIG. 2B depicts computing a minimum distance and a maximum distance along an individual ray by intersecting the ray with two planes having a constant y value within an exemplary three dimensional scene, in accordance with one embodiment of the present invention.

FIG. 2C depicts a computed minimum distance and a computed maximum distance along an individual ray within an exemplary three dimensional scene, in accordance with one embodiment of the present invention.

FIG. 2D depicts a computed minimum distance and a computed maximum distance along an individual ray with respect to an axis-aligned box within an exemplary three dimensional scene, in accordance with one embodiment of the present invention.

FIG. 3 depicts a flowchart of an exemplary computer graphics process of performing ray traversal using integer comparisons, in accordance with one embodiment of the present invention.

FIG. 4 depicts a flowchart of an exemplary computer graphics process of computing the minimum and maximum distances along an individual ray, in accordance with one embodiment of the present invention.

### DETAILED DESCRIPTION OF THE INVENTION

Reference will now be made in detail to embodiments of the present invention, examples of which are illustrated in the accompanying drawings. While the present invention will be discussed in conjunction with the following embodiments, it will be understood that they are not intended to limit the present invention to these embodiments alone. On the contrary, the present invention is intended to cover alternatives, modifications, and equivalents which may be included with the spirit and scope of the present invention as defined by the appended claims. Furthermore, in the following detailed description of the present invention, numerous specific details are set forth in order to provide a thorough understanding of the present invention. However, embodiments of the present invention may be practiced without these specific details. In other instances, well-known methods, procedures, components, and circuits have not been described in detail so as not to unnecessarily obscure aspects of the present invention.

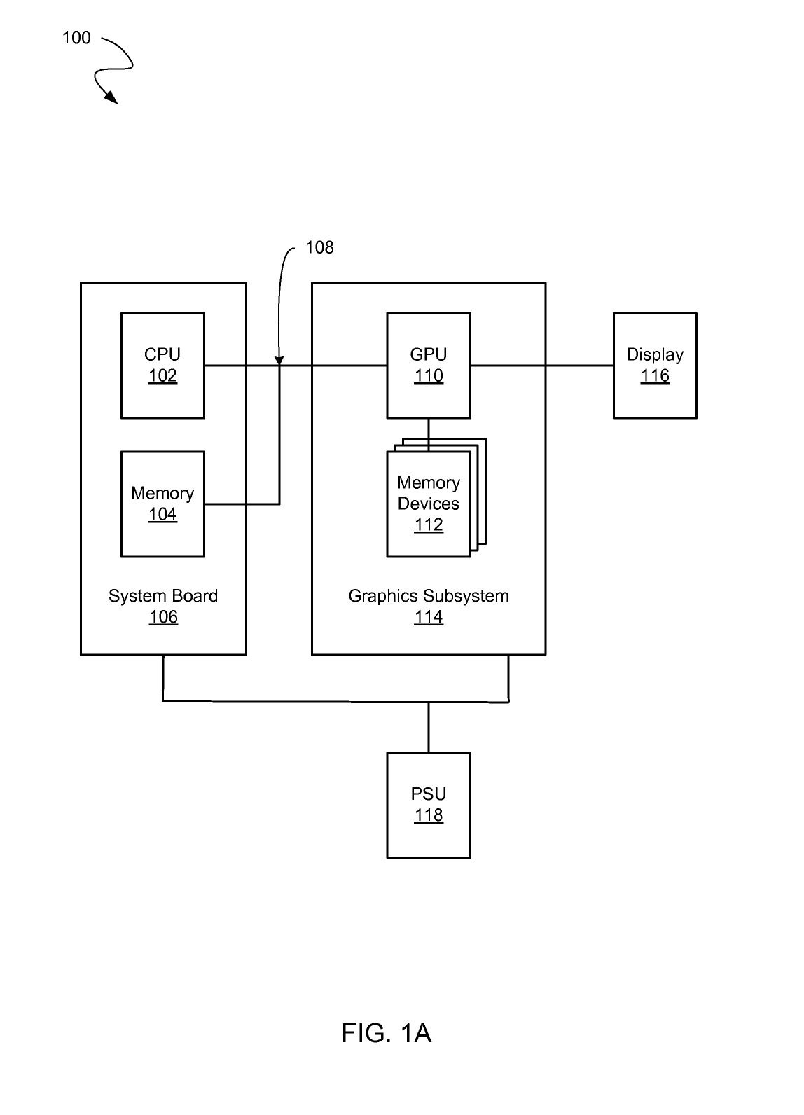

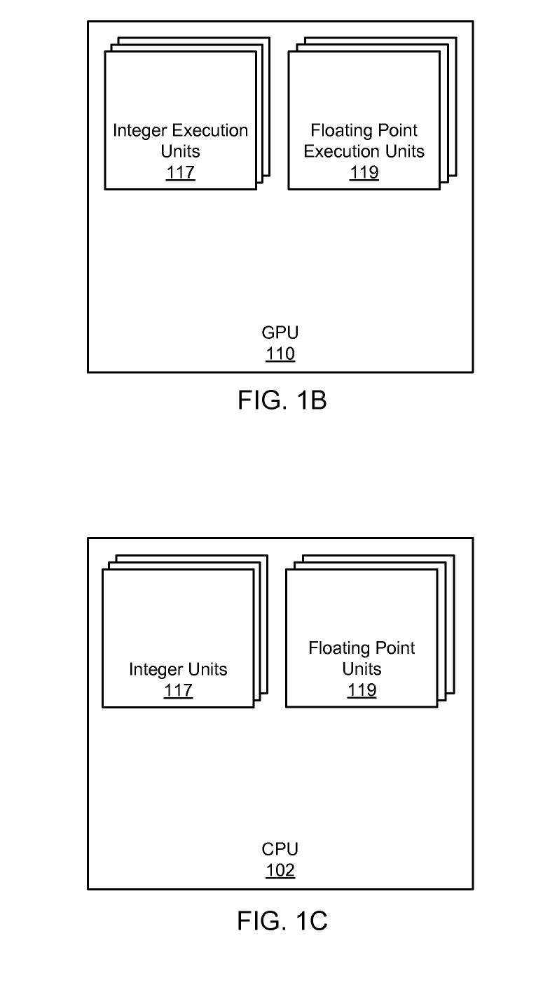

FIG. 1A shows an exemplary computer system 100 in accordance with one embodiment of the present invention. Computer system 100 depicts the components in accordance with embodiments of the present invention providing the execution platform for certain hardware-based and software-based functionality, in particular, computer graphics rendering and display capability. In general, computer system 100 comprises a system board 106 including at least one central processing unit (CPU) 102 and a system memory 104. The CPU 102 can be coupled to the system memory 104 via a bridge component/memory controller (not shown) or can be directly coupled to the system memory 104 via a memory controller (not shown) internal to the CPU 102.

Computer system 100 also comprises a graphics subsystem 114 including at least one graphics processor unit (GPU) 110. For example, the graphics subsystem 114 may be included on a graphics card. The graphics subsystem 114 may be coupled to a display 116. One or more additional GPU(s) 110 can optionally be coupled to computer system 100 to further increase its computational power. The GPU(s) 110 may be coupled to the CPU 102 and the system memory 104 via a communication bus 108. The GPU 110 can be implemented as a discrete component, a discrete graphics card designed to couple to the computer system 100 via a connector (e.g., AGP slot, PCI-Express slot, etc.), a discrete integrated circuit die (e.g., mounted directly on a motherboard), or as an integrated GPU included within the integrated circuit die of a computer system chipset component (not shown). Additionally, memory devices 112 may be coupled with the GPU 110 for high bandwidth graphics data storage, e.g., the frame buffer. In an embodiment, the memory devices 112 may be dynamic random-access memory. A power source unit (PSU) 118 may provide electrical power to the system board 106 and graphics subsystem 114.

The CPU 102 and the GPU 110 can also be integrated into a single integrated circuit die and the CPU and GPU may share various resources, such as instruction logic, buffers, functional units and so on, or separate resources may be provided for graphics and general-purpose operations. The GPU may further be integrated into a core logic component. Accordingly, any or all the circuits and/or functionality described herein as being associated with the GPU 110 can also be implemented in, and performed by, a suitably equipped CPU 102. Additionally, while embodiments herein may make reference to a GPU, it should be noted that the described circuits and/or functionality can also be implemented and other types of processors (e.g., general purpose or other special-purpose coprocessors) or within a CPU.

System 100 can be implemented as, for example, a desktop computer system or server computer system having a powerful general-purpose CPU 102 coupled to a dedicated graphics rendering GPU 110. In such an embodiment, components can be included that add peripheral buses, specialized audio/video components, IO devices, and the like. Similarly, system 100 can be implemented as a portable device (e.g., cellphone, PDA, etc.), direct broadcast satellite (DBS)/terrestrial set-top box or a set-top video game console device such as, for example, the Xbox®, available from Microsoft Corporation of Redmond, Wash., or the PlayStation3®, available from Sony Computer Entertainment Corporation of Tokyo, Japan. System 100 can also be implemented as a “system on a chip”, where the electronics (e.g., the components 102, 104, 110, 112, and the like) of a computing device are wholly contained within a single integrated circuit die. Examples include a hand-held instrument with a display, a car navigation system, a portable entertainment system, and the like.

FIG. 1B shows an exemplary graphics processing unit (GPU) 110 comprising a plurality of integer execution units 117 and a plurality of floating point execution units 119, in accordance with one embodiment of the present invention. The integer execution units 117 perform arithmetic and logical operations on integer operands within the GPU 110. The floating point execution units 119 perform arithmetic and logical operations on floating point operands within the GPU 110. If execution of a particular program makes use of only floating point operands, only the floating point execution units 119 will be active and the integer execution units 117 will be idle.

FIG. 1C shows an exemplary central processing unit (CPU) 102 comprising a plurality of integer execution units 117 and a plurality of floating point execution units 119, in accordance with one embodiment of the present invention. FIG. 1C is similar to FIG. 1B except that the integer execution units 117 and the floating point execution units 119 reside within a CPU 102.

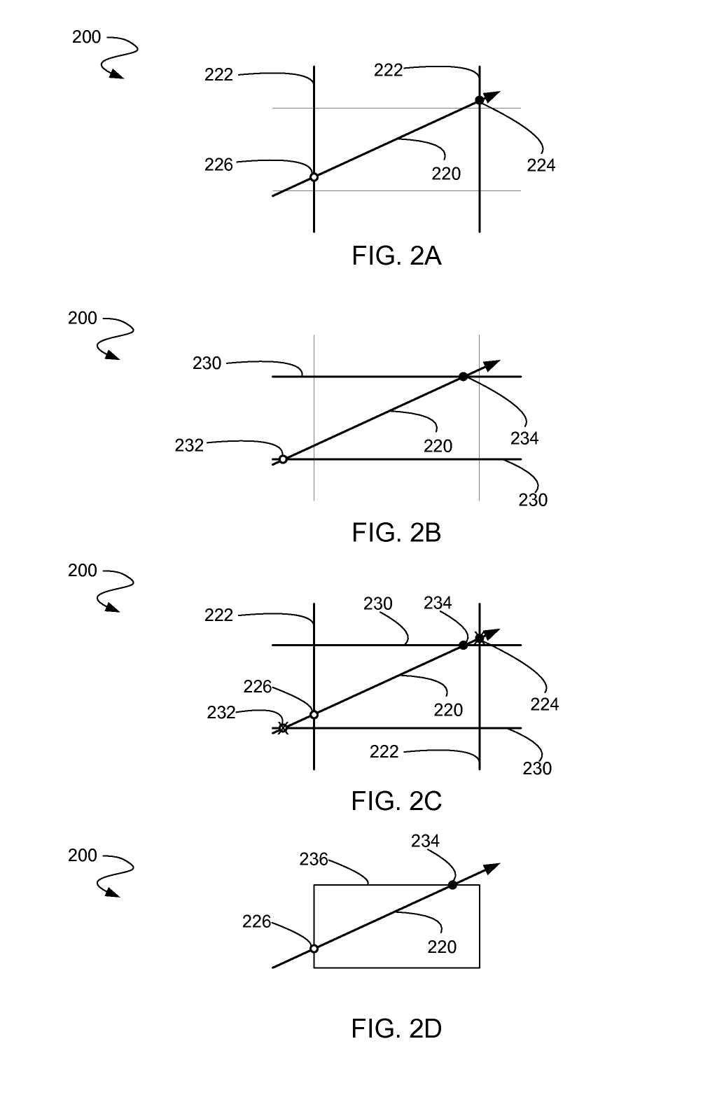

FIG. 2A depicts computing a minimum distance and a maximum distance along an individual ray 220 by intersecting the ray 220 with two planes 222 having a constant x value within an exemplary three dimensional scene 200, in accordance with one embodiment of the present invention. The exemplary scene 200 may be represented in computer memory as graphics data stored therein. The three dimensional scene 200 is a three dimensional model intended to be converted into a 2-D image by a computer graphics processing system for image display.

The three dimensional scene 200 comprises a ray 220. The ray 220 is cast from a point toward the scene 200. In an embodiment, the image is rendered using ray tracing, a technique for generating an image by tracing the path of light through pixels in an image plane and simulating the effects of its encounters with virtual objects.

The scene 200 also comprises objects with object surfaces (not shown). Individual ray 220 is intersected with two vertical (x=constant) planes 222. Intersecting individual ray 220 with two vertical planes 222 results in computed values for tmin_x 226 and tmax_x 224. Values tmin_x 226 and tmax_x 224 are the minimum and maximum distances for x-axis overlap along individual ray 220, respectively. Values tmin_x 226 and tmax_x 224 are used to later compute the overall minimum distance and maximum distance along individual ray 220 with respect to an axis-aligned box, as described below in FIG. 2C.

FIG. 2B depicts computing a minimum distance and a maximum distance along an individual ray 220 by intersecting the ray 220 with two planes 230 having a constant y value within an exemplary three dimensional scene 200, in accordance with one embodiment of the present invention.

FIG. 2B is similar to FIG. 2A except that individual ray 220 is intersected with two horizontal (y=constant) planes 230 instead of two vertical (x=constant) planes. Intersecting individual ray 220 with two horizontal planes 222 results in computed values for tmin_y 232 and tmax_y 234. Values tmin_y 232 and tmax_y 234 are the minimum and maximum distances for y-axis overlap along individual ray 220, respectively. Values tmin_y 232 and tmax_y 234 are used to later compute the overall minimum distance and maximum distance along individual ray 220 with respect to an axis-aligned box, as described below in FIG. 2C.

In an embodiment, individual ray 220 may be intersected with two z=constant planes (not shown) when the scene consists of three dimensions, resulting in computed values for tmin_z and tmax_z. Values tmin_z and tmax_z are the minimum and maximum distances for z-axis overlap along individual ray 220, respectively.

FIG. 2C depicts a computed minimum distance and a computed maximum distance along an individual ray within an exemplary three dimensional scene, in accordance with one embodiment of the present invention. After intersecting individual ray 220 with two vertical planes 222 and two horizontal planes 230, as described in FIG. 2A and FIG. 2B, overall minimum and maximum distances along the ray 220 can be computed. Value tmin is the largest of tmin_x 226, tmin_y 232 and tmin_z (computed in FIG. 2A and FIG. 2B). Similarly, tmax is the smallest of tmax_x 224, tmax_y 234 and tmax_z (computed in FIG. 2A and FIG. 2B). In this particular example, tmin is equal to tmin_x 226 and tmax is equal to tmax_y 234. Previously computed values tmax_x 224 and tmin_y 232 are eliminated.

FIG. 2D depicts a computed minimum distance (tmin) 226 and a computed maximum distance (tmax) 234 along an individual ray 220 with respect to an axis-aligned box 236 within an exemplary three dimensional scene 200, in accordance with one embodiment of the present invention. Axis-aligned box 236 is formed by the enclosed area of intersections between two vertical planes 222 and two horizontal planes 230. Using the computed results for tmin 226 and tmax 234, it can be determined whether the resulting span overlaps with the individual ray's 220 extents. From this determination, intersections of individual ray 220 can be calculated.

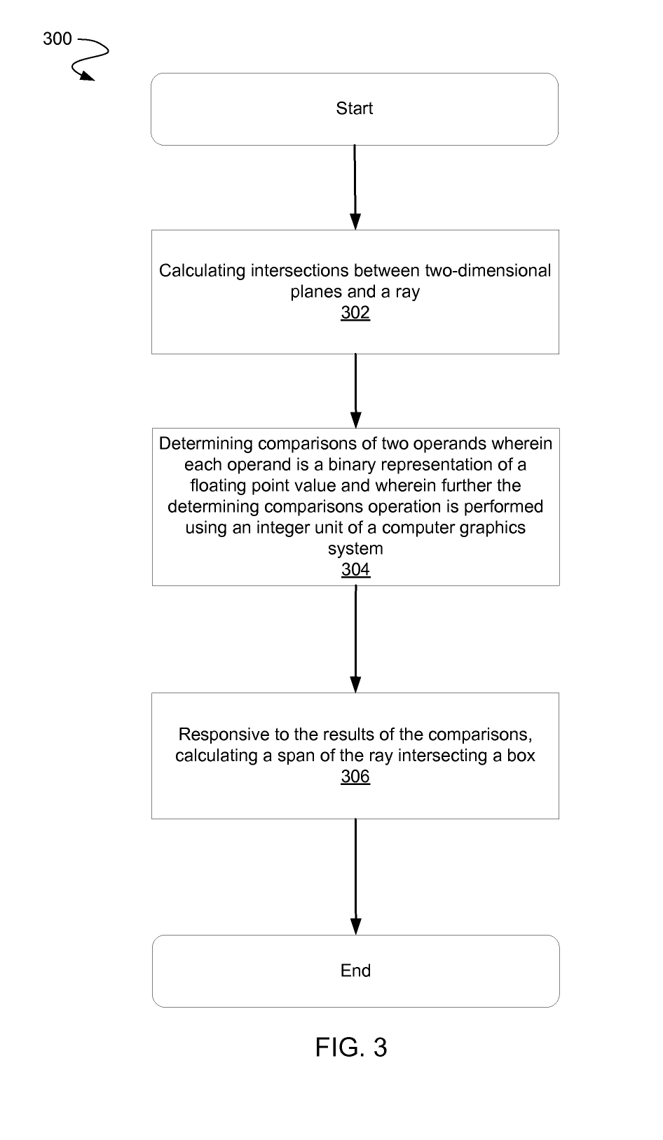

FIG. 3 depicts a flowchart 300 of an exemplary computer graphics process of performing ray traversal using integer comparisons, in accordance with one embodiment of the present invention. The computer-controlled process of flowchart 300 may be implemented on the system of FIG. 1A. More specifically, flowchart 300 describes performing ray traversal wherein the ray traversal comprises performing a ray-box intersection test to determine boxes intersected by a ray. In another embodiment, the performing ray traversal further comprises using intersections of an individual ray to determine intersections of the individual ray with a next box.

In block 302, as part of the ray-box intersection test, intersections between two-dimensional planes and the ray are calculated.

In block 304, comparisons of two operands are determined wherein each operand is a binary representation of a floating point value and wherein further the determining comparisons operation is performed using an integer unit of a computer graphics system.

In another embodiment, comparisons of two operands are determined wherein each operand is a binary representation of a floating point value and wherein further the determining comparisons operation is performed using a floating point unit of a computer graphics system. It can be appreciated that the determining comparisons operation can be performed using a mixture of integer units and floating point units.

In block 306, responsive to the results of the comparisons, span intersections of the boxes are calculated.

The method described in FIG. 3 may be software implemented or hardware implemented or both. Example pseudocode of a traditional method of calculating intersections follows in Table 1 below:

TABLE 1
DEFINITIONS
B = Box (xmin,ymin,zmin,xmax,ymax,zmax)
O = ray origin (x,y,z)
D = ray direction (x,y,z)
invD = (1/D.x,1/D.y,1/D.z)
OoD = (O.x/D.x,O.y/D.y,O.z/D.z)
tminray = ray segment's minimum t value, >=0
tmaxray = ray segment's maximum t value, >=0
RAY-BOX
// Plane intersections (6 × FMA)

| | |
|---|---|
| float x0 = B.xmin*invD[x] − OoD[x]; | // entire floating point range |
| float y0 = B.ymin*invD[y] − OoD[y]; | // entire floating point range |
| float z0 = B.zmin*invD[z] − OoD[z]; | // entire floating point range |
| float x1 = B.xmax*invD[x] − OoD[x]; | // entire floating point range |
| float y1 = B.ymax*invD[y] − OoD[y]; | // entire floating point range |
| float z1 = B.zmax*invD[z] − OoD[z]; | // entire floating point range |

// Span intersection (12 × 2-way min/max)
float tminbox = max4(tminray, min2(x0,x1), min2(y0,y1), min2(z0,z1));
float tmaxbox = min4(tmaxray, max2(x0,x1), max2(y0,y1), max2(z0,z1));
// Overlap test (1 × FSET)
bool intersect = (tminbox<=tmaxbox);

The pseudocode of Table 1 involves a significant number of operations for selecting minimum or maximum floating point values. However, the present invention discloses performing such operations as described in Table 1 using integer units operating on binary representations of floating point values. Since the integer unit would otherwise be idle, it is desirable to use integer instructions instead of floating point instructions when correct results can be guaranteed. A secondary advantage to using integer instructions is that integer instructions offer higher throughput and lower power consumption.

The table below displays a method of calculating intersections using integer representations of floating point values:

TABLE 2
DEFINITIONS
B = Box (xmin,ymin,zmin,xmax,ymax,zmax)
O = ray origin (x,y,z)
D = ray direction (x,y,z)
invD = (1/D.x,1/D.y,1/D.z)
OoD = (O.x/D.x,O.y/D.y,O.z/D.z)
tminray = ray segment's minimum t value, >=0
tmaxray = ray segment's maximum t value, >=0
RAY-BOX
// Plane intersections (6 × FMA)

| | |
|---|---|
| float x0 = B.xmin*invD[x] − OoD[x]; | // entire floating point range |
| float y0 = B.ymin*invD[y] − OoD[y]; | // entire floating point range |
| float z0 = B.zmin*invD[z] − OoD[z]; | // entire floating point range |
| float x1 = B.xmax*invD[x] − OoD[x]; | // entire floating point range |
| float y1 = B.ymax*invD[y] − OoD[y]; | // entire floating point range |
| float z1 = B.zmax*invD[z] − OoD[z]; | // entire floating point range |

// Span intersection (6 × 3-way minmax)
float tminbox = min.max(x0,x1, min.max(y0,y1, min.max(z0,z1,
tminray)));
float tmaxbox = max.min(x0,x1, max.min(y0,y1, max.min(z0,z1,
tmaxray)));
// Overlap test (1 × FSET)
bool intersect = (tminbox<=tmaxbox);

Table 2 illustrates calculating span intersections using integer representations of floating point values when utilizing a three-way integer minmax unit. It can be appreciated that a three-way integer minmax unit may exist even when a 3-way floating point unit does not. The pseudocode in Table 2 consists of 13 instructions while the pseudocode of Table 1 consists of 19 instructions. Thus, instruction throughput is generally improved.

It is well known in the art that an integer comparison gives the correct result for floating point data as long as at least one of the arguments is non-negative. Referring back to Table 1, by construction, tminray is non-negative and thus tminbox will also be non-negative. Therefore, it does not matter that min2(x0,x1), min2(y0,y1), and min2(z0,z1) may give wrong intermediate results. When the largest of these and tminbox is chosen, the potentially incorrect negative values will not be selected.

tmaxbox may be an incorrect value because max2(x0,x1), max2(y0,y1), and max2(z0,z1) may select the wrong negative numbers. In this case, it is of no use that tmaxray is non-negative because the smallest number is selected. Regardless, max2(x0,x1) is negative only when both of the ray's intersections with x-aligned planes are behind the ray's origin, in which case the ray segment cannot intersect the box. The same is true for the y-aligned and z-aligned planes. In these cases, intersect must be set to false, which is what happens even when tmaxray is an incorrect negative number.

Thus, even though most of the intermediate results may indeed be incorrect, all of the end results are guaranteed to be correct in the particular methods described in the pseudocodes of Table 1 and Table 2.

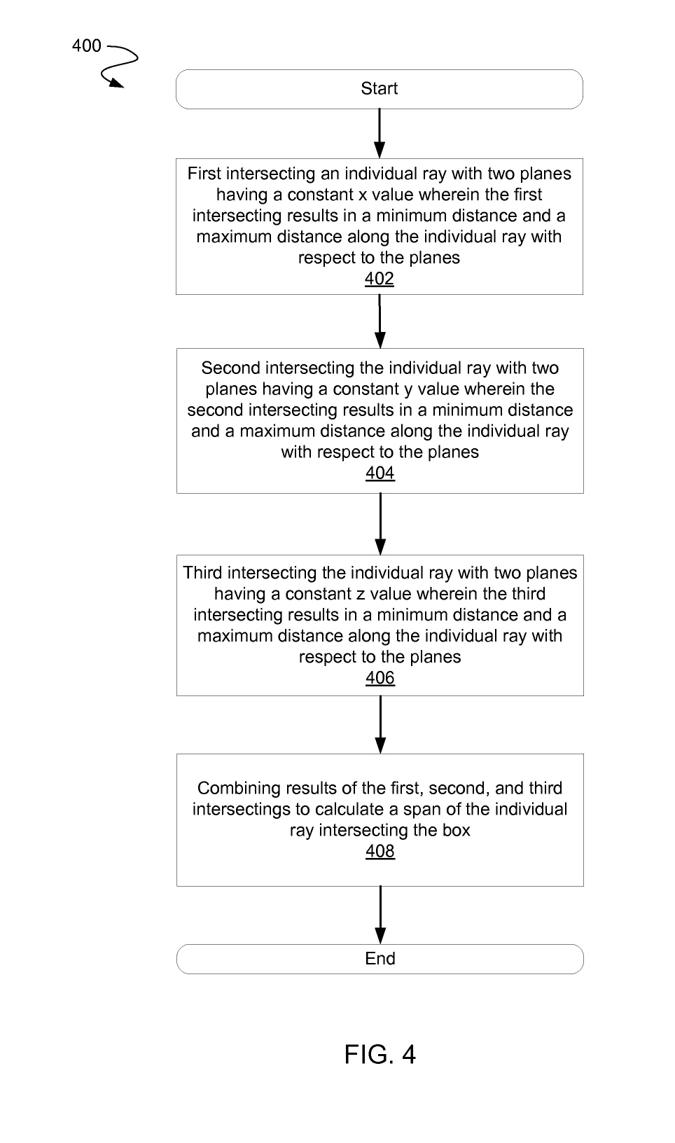

FIG. 4 depicts a flowchart 400 of an exemplary computer graphics process of computing the minimum and maximum distances along an individual ray, in accordance with one embodiment of the present invention. The computer-controlled process of flowchart 400 may be implemented on the system of FIG. 1A. In block 402, an individual ray is first intersected with two planes having a constant x value wherein the first intersecting results in a minimum distance and a maximum distance along the individual ray with respect to the planes. For example, in FIG. 2A, individual ray is intersected with two planes having a constant x value. The intersecting of the rays results in a minimum distance and a maximum distance along the individual ray with respect to the two planes having a constant x value.

In block 404, an individual ray is second intersected with two planes having a constant y value wherein the second intersecting results in a minimum distance and a maximum distance along the individual ray with respect to the planes. For example, in FIG. 2B, individual ray is intersected with two planes having a constant y value. The intersecting of the rays results in a minimum distance and a maximum distance along the individual ray with respect to the two planes having a constant y value.

In block 406, an individual ray is third intersected with two planes having a constant z value wherein the third intersecting results in a minimum distance and a maximum distance along the individual ray with respect to the planes. The individual ray is intersected with two planes having a constant z value when the scene consists of three dimensions.

In block 408, the results of the first, second, and third intersectings are combined to calculate a span of the individual ray intersecting the box. For example, in FIG. 2D, the results of intersecting the individual ray with two planes having a constant x value and two planes having a constant y value are combined to calculate a span of the individual ray intersecting the axis-aligned box.

In the foregoing specification, embodiments of the invention have been described with reference to numerous specific details that may vary from implementation to implementation. Thus, the sole and exclusive indicator of what is, and is intended by the applicants to be, the invention is the set of claims that issue from this application, in the specific form in which such claims issue, including any subsequent correction. Hence, no limitation, element, property, feature, advantage, or attribute that is not expressly recited in a claim should limit the scope of such claim in any way. Accordingly, the specification and drawings are to be regarded in an illustrative rather than a restrictive sense.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings.

What is claimed is:

1. A method of ray tracing in a computer graphics system comprising integer units and floating point units, said method comprising:
performing ray traversal wherein said ray traversal comprises performing a ray-box intersection test to determine boxes intersected by a ray, wherein said ray-box intersection test comprises:
calculating intersections between two-dimensional planes and said ray;
determining comparisons of two operands wherein each operand is a binary representation of a floating point value and wherein further said determining comparisons operation is performed using an integer unit of said computer graphics system; and
responsive to results of said comparisons, calculating a span of the ray intersecting said box.

2. The method of claim 1 wherein said ray-box intersection test further comprises:
first intersecting an individual ray with two planes having a constant x value wherein said first intersecting results in a minimum distance and a maximum distance along said individual ray with respect to said planes;
second intersecting said individual ray with two planes having a constant y value wherein said second intersecting results in a minimum distance and a maximum distance along said individual ray with respect to said planes;
third intersecting said individual ray with two planes having a constant z value wherein said third intersecting results in a minimum distance and a maximum distance along said individual ray with respect to said planes;
combining results of said first, second, and third intersectings to calculate said span of said individual ray intersecting said box.

3. The method of claim 1 wherein said performing ray traversal further comprises using intersections of an individual ray to determine intersections of said individual ray with a next box.

4. The method of claim 1 wherein said boxes comprise objects within a three-dimensional scene.

5. The method of claim 1 wherein said two operands comprise distances along an individual ray with respect to said planes.

6. The method of claim 1 wherein said ray-box intersection test further comprises determining comparisons of two operands wherein each operand is a binary representation of a floating point value and wherein further said determining comparisons operation is performed using a floating point unit of said computer graphics system.

7. The method of claim 1 wherein said method of ray tracing is used for image rendering within said computer graphics system.

8. A computer readable storage medium having stored thereon, computer executable instructions that, if executed by a computer system cause the computer system to perform a method of ray tracing in a computer graphics system comprising integer units and floating point units, said method comprising:
performing ray traversal wherein said ray traversal comprises performing a ray-box intersection test to determine boxes intersected by a ray, wherein said ray-box intersection test comprises:
calculating intersections between two-dimensional planes and said ray;
determining comparisons of two operands wherein each operand is a binary representation of a floating point value and wherein further said determining comparisons operation is performed using an integer unit of said computer graphics system; and
responsive to results of said comparisons, calculating a span of the ray intersecting said box.

9. The computer readable storage medium of claim 8, wherein said ray-box intersection test further comprises:
first intersecting an individual ray with two planes having a constant x value wherein said first intersecting results in a minimum distance and a maximum distance along said individual ray with respect to said planes;
second intersecting said individual ray with two planes having a constant y value wherein said second intersecting results in a minimum distance and a maximum distance along said individual ray with respect to said planes;
third intersecting said individual ray with two planes having a constant z value wherein said third intersecting results in a minimum distance and a maximum distance along said individual ray with respect to said planes;
combining results of said first, second, and third intersectings to calculate said span of said individual ray intersecting said box.

10. The computer readable storage medium of claim 9 wherein said performing ray traversal further comprises using intersections of an individual ray to determine intersections of said individual ray with a next box.

11. The computer readable storage medium of claim 8 wherein said boxes comprise objects within a three-dimensional scene.

12. The computer readable storage medium of claim 8 wherein said two operands comprise distances along an individual ray with respect to said planes.

13. The computer readable storage medium of claim 8 wherein said ray-box intersection test further comprises determining comparisons of two operands wherein each operand is a binary representation of a floating point value and wherein further said determining comparisons operation is performed using a floating point unit of said computer graphics system.

14. The computer readable storage medium of claim 8 wherein said method of ray tracing is used for image rendering within said computer graphics system.

15. A system comprising:
a processor coupled to a computer readable storage media using a bus and executing computer readable code which causes the computer system to perform a method of ray tracing in a computer graphics system comprising integer units and floating point units, said method comprising:
performing ray traversal wherein said ray traversal comprises performing a ray-box intersection test to determine boxes intersected by a ray, wherein said ray-box intersection test comprises:
calculating intersections between two-dimensional planes and said ray;
determining comparisons of two operands wherein each operand is a binary representation of a floating point value and wherein further said determining comparisons operation is performed using an integer unit of said computer graphics system; and
responsive to results of said comparisons, calculating a span of the ray intersecting said box.

16. The system of claim 15, wherein said ray-box intersection test further comprises:
first intersecting an individual ray with two planes having a constant x value wherein said first intersecting results in a minimum distance and a maximum distance along said individual ray with respect to said planes;
second intersecting said individual ray with two planes having a constant y value wherein said second intersecting results in a minimum distance and a maximum distance along said individual ray with respect to said planes;
third intersecting said individual ray with two planes having a constant z value wherein said third intersecting results in a minimum distance and a maximum distance along said individual ray with respect to said planes;
combining results of said first, second, and third intersectings to calculate said span of said individual ray intersecting said box.

17. The system of claim 15 wherein said performing ray traversal further comprises said intersections of an individual ray to determine intersections of said individual ray with a next box.

18. The system of claim 15 wherein said boxes comprise objects within a three-dimensional scene.

19. The system of claim 15 wherein said two operands comprise distances along an individual ray with respect to said planes.

20. The system of claim 15 wherein said ray-box intersection test further comprises determining comparisons of two operands wherein each operand is a binary representation of a floating point value and wherein further said determining comparisons operation is performed using a floating point unit of said computer graphics system.
